(19) United States
(12) Patent Application Publication
(10) Pub. No.: US 2025/0224530 A1
(43) Pub. Date: Jul. 10, 2025

(54) BAYESIAN SYSTEMS FOR SEISMIC FAULT DETECTION

(71) Applicant: Saudi Arabian Oil Company, Dhahran (SA)

(72) Inventor: BingBing Sun, Dhahran (SA)

(21) Appl. No.: 18/404,353

(22) Filed: Jan. 4, 2024

(51) Int. Cl. G01V 1/30; E21B 49/00; G01V 1/28; G01V 1/34

(52) U.S. Cl. CPC G01V 1/306; G01V 1/282; G01V 1/302; G01V 1/345; G01V 2210/1234; G01V 2210/144; G01V 2210/161; G01V 2210/642; G01V 2210/646; G01V 2210/665; G01V 2210/667

(57) ABSTRACT

Systems and methods are configured for identifying faults or fractures in a subsurface region for performing hydrocarbon extraction. The systems and methods execute a Bayesian neural network on seismic images to generate, for locations in the seismic images, predictions of the presence or absence of faults and fractures in the subsurface region. The predictions are associated with uncertainty values. The locations of wells are selected for drilling based on the predictions and the associated uncertainty values.

### TECHNICAL FIELD

The present disclosure relates to wellbore drilling, such as for hydrocarbon extraction. More specifically, the disclosure describes techniques for determining a volume of a wellbore outside of a casing inserted into the wellbore.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays a role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications, for example, identification of potential petroleum reservoirs. Seismic surveys are conducted by using a controlled seismic source (for example, a seismic vibrator or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources, for example, borehole logging, gravity surveys, and magnetic surveys.

### SUMMARY

Systems and methods described in this disclosure are configured for seismic fault detection using one or more Bayesian deep learning neural network data processing models. The systems and methods are configured for controlling hydrocarbon exploration, such as drilling one or more wells in a subsurface, based on the results of the applied Bayesian data processing model. A data processing system can train the data processing model using paired seismic images and corresponding fault or fractures labels. The data processing system is configured to execute the Bayesian data processing model for generating prediction outputs based on variational inferences made from the data processing system model.

Generally, the data processing system can generate predictions of faults and fractures with associated uncertainty values for reservoir characterization. The data processing system provides an improved accuracy for delineation of faults and fractures, relative to data processing models, including machine learning based models, which do not generate uncertainty values associated with the predictions of the faults and/or fractures.

The one or more embodiments described in this specification can enable one or more of the following advantages. For large datasets, machine learning methods can be used for fast and automatic fault detection for large seismic volumes. The data processing system described herein is configured to generate associated uncertainties for the picked faults. The data processing system can generate predictions for improved placement of wells relative to systems that consider fault detection as a classification problem, such as machine learning methods that learn a point estimator of the weights. The data processing system and model described herein is configured to learn a distribution for the weights of the neural network. Specifically, the data processing system is configured to train the machine learning model to learn a marginal posterior distribution such that the machine learning model includes a Bayesian neural network. The data processing system trains the Bayesian neural network by maximizing an evidence lower bound (ELBO) value. The data processing system uses a Gaussian distribution for both a prior and variational posterior. Stochastic gradient descent leads to an efficient training of the Bayesian neural network. By sampling the predictive distribution, the data processing system performs the uncertainty analysis. To learn a distribution rather than a fixed value for the weight reduces an overfitting issue of training deep neural networks.

The data processing system can produce a more accurate prediction for faults and fractures. The data processing system can cause or control both improved well placement and well drilling, relative to well placement and drilling based on prior machine learning models or other approaches to classification of faults and fractures. The improved placement of wells can result in a greater chance of successful production from the drilled wells.

Embodiments of these systems and methods can include one or more of the following features.

In a general aspect, a process for identifying faults or fractures in a subsurface for performing hydrocarbon extraction includes the following. The process includes receiving a seismic image generated from a plurality of seismic traces, the seismic image representing features in the subsurface based on reflections of the plurality of seismic traces. The process includes accessing a data processing model, the data processing model trained to generate output values based on a prior distribution associated with one or more machine learning parameters and a posterior distribution associated with the one or more machine learning parameters. The process includes processing the seismic image using the data processing model. The processing includes sampling a value from the posterior distribution, updating the one or more machine learning parameters based on the sampled value, and generating a prediction value for one or more locations in the seismic image, the prediction value specifying a presence or absence of a fault or fracture at a location in the seismic image. The process includes, based on the processing, generating an uncertainty value associated with the prediction value, the uncertainty value based on processing the seismic image with at least two values from the posterior distribution. The process includes generating an output representation of the uncertainty value and the prediction value specifying the presence or the absence of the fault or the fracture at the location in the seismic image.

In some implementations, the process includes, based on the prediction value and the uncertainty value, generating a control signal configured for causing drilling of a well in the subsurface corresponding to the location in the seismic image.

In some implementations, the data processing model comprises a Bayesian neural network.

In some implementations, the data processing model is trained using one or more seismic images labeled with fault or fracture labels, wherein the training comprises maximizing an evidence lower bound value based on a stochastic gradient ascent.

In some implementations, the process includes performing iterations of the processing the seismic image using the data processing model until a threshold value is satisfied for the uncertainty for at least one location in the seismic image.

In some implementations, sampling comprises a random sampling across the posterior distribution.

In some implementations, the distribution comprises a Gaussian distribution.

In some implementations, a machine learning parameter of the one or more machine learning parameters comprises a neural network bias value. In some implementations, a machine learning parameter of the one or more machine learning parameters comprises a neural network weight value. In some implementations, the location in the seismic image comprises a pixel in the seismic image.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The details of one or more embodiments are set forth in the accompanying drawings and the description below. Other features and advantages will be apparent from the description and drawings, and from the claims.

### DESCRIPTION OF DRAWINGS

FIG. 1 is a schematic view of a system for performing a seismic survey.

FIG. 2 illustrates a seismic cube representing at least a portion of a subterranean formation.

FIG. 3 illustrates a seismic cube representing a subterranean formation.

FIGS. 4A, 4B, and 4C schematically illustrate the process of stacking a group of seismic traces.

FIG. 5A shows flow diagram illustrating an example process for training a data processing model for seismic fault detection from seismic image.

FIG. 5B shows flow diagram illustrating an example process for executing a trained data processing model for performing seismic fault detection from one or more seismic images.

FIG. 5C shows flow diagram illustrating an example process for executing a trained data processing model for performing seismic fault detection from one or more seismic images.

FIG. 6 is a block diagram illustrating a data processing system.

FIGS. 7A-7B are images showing training data for a data processing system.

FIGS. 8A-8C are images showing a processing of seismic image by a data processing system.

FIG. 9 is an image showing output data.

FIG. 10 illustrates hydrocarbon production operations.

FIG. 11 is a diagram of an example computing system.

Like reference numbers and designations in the various drawings indicate like elements.

### DETAILED DESCRIPTION

Systems and methods described in this disclosure are configured for seismic fault detection using one or more Bayesian deep learning neural network data processing models. The systems and methods are configured for controlling hydrocarbon exploration, such as drilling one or more wells in a subsurface, based on the results of the applied Bayesian data processing model. A data processing system can train the data processing model using paired seismic images and corresponding fault or fractures labels. The data processing system is configured to execute the Bayesian data processing model for generating prediction outputs based on variational inferences made from the data processing system model.

The data processing model including a Bayesian neural network is configured to produce a distribution of the neural network parameters. The neural network parameters include weights and biases of nodes of the neural network. Specifically, the data processing system trains the data processing model to learn a variational posterior distribution of the neural network parameters. The data processing system samples from the variational posterior distribution of the neural network parameters to generate multiple predictions with a single input to the data processing model. The data processing system can perform an uncertainty analysis based on the multiple predictions. The variations of the data processing model stabilize the training process and reduce overfitting that can occur with neural networks trained by a point estimator.

The data processing system uses the fault detection of the data processing model for seismic oil and gas exploration. The geometry of faults typically reveals accumulation and migration of geological resources. The data processing model and the associated uncertainty provide a robust fault detection. The data processing system uses the predictions from the data processing model for reservoir characterization and well placement.

Faults can be detected based on reflection discontinuities. Fault detection methods can enhance such discontinuities by computation of attributes such as eigen-structure coherence, gradient structure tensor, energy-ratio similarity, variance, and curvature. These fault detection methods can highlight faults on three-dimensional (3D) seismic data.

The data processing model executed by the data processing system as described herein can improve a robustness and accuracy of the fault detection methods, such as for complex geological tectonic zones. The data processing system can account for uncertainty in the picked faults. Additionally, the data processing model described herein does not require computing seismic attributes on a per-pixel basis, which enables the data processing system to process relatively large datasets in seismic exploration. The data processing system is not limited outputting a predicted attribute for single pixel at one time.

The data processing system also is improved relative to some machine learning algorithms for feature extraction including Convolutional Neural Networks (CNN) and Generative Adversarial Networks (GANs), which are typically associated with high-performance computation such as use of graphical processing units (GPUs) for neural network training. These models are applied to seismic data denoising and interpolation, waveform-based imaging and inversion, impedance inversion, and facies classification, and fault detection. The machine learning based approaches can consider the task of seismic fault detection as a semantic segmentation problem, and each pixel in the seismic image volume is identified as faults or non-faults by binary classifications. The data processing model describe herein can also determine associated uncertainties related to picked faults and fractures. The data processing system, based on the determined uncertainties, generates improved predictions for faults and fractures relative to the machine learning models that do not generate uncertainty data. The improved predictions of the data processing system enable improved likelihood of drilling and well-placement success, relative to methods that do not include uncertainties associated with the faults and fractures predictions.

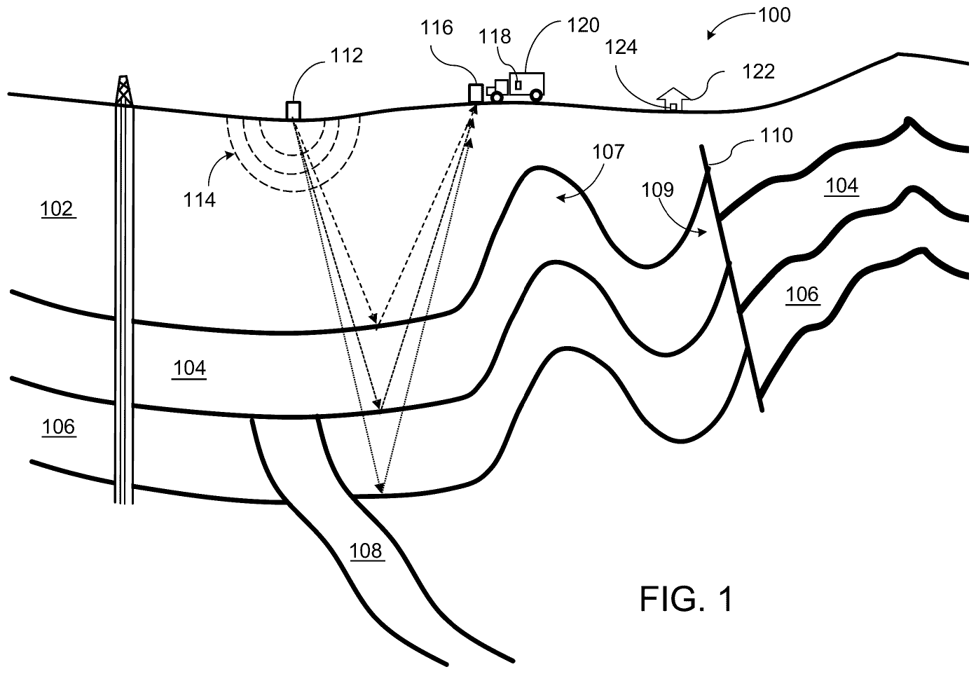

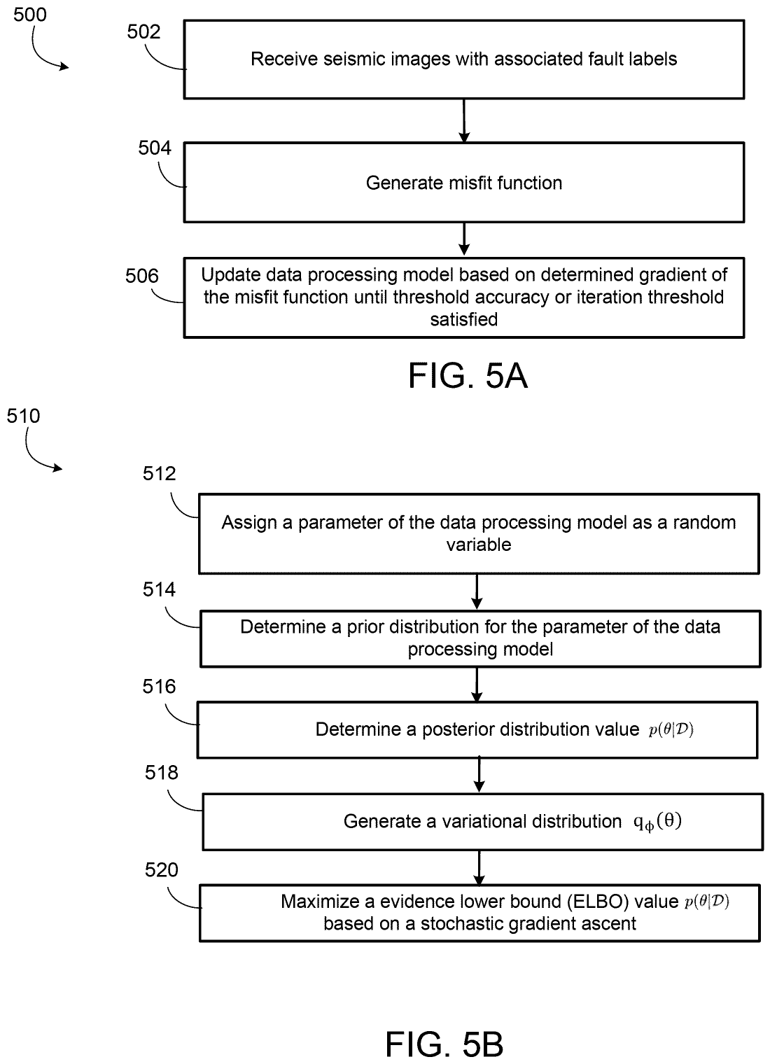

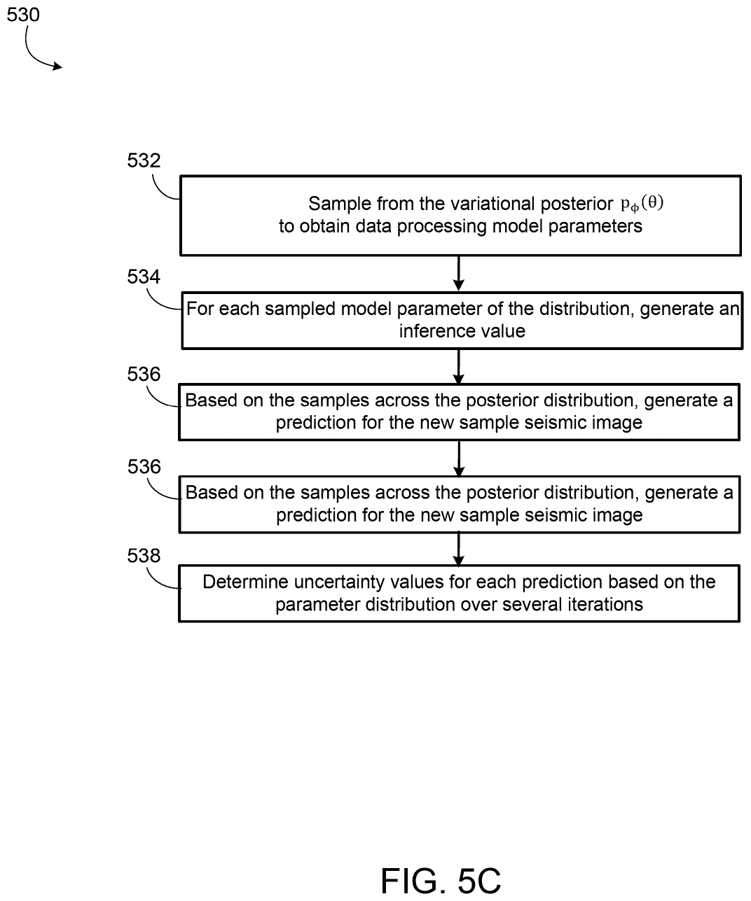

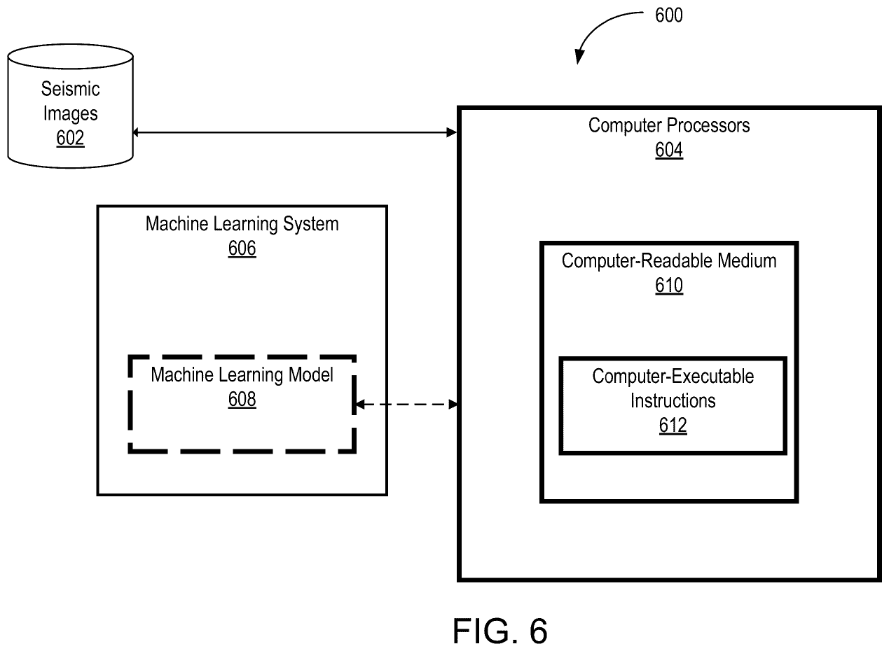

FIG. 1 is a schematic view of a seismic survey being performed to map subterranean features such as facies and faults in a subterranean formation 100. The seismic survey provides the underlying basis for implementation of the systems and methods described with reference to FIGS. 5A-6. The subterranean formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves 114 that propagate in the earth. The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic waves 114 contact interfaces between geologic bodies or layers that have different velocities, the interfaces reflect some of the energy of the seismic wave and refracts some of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate output signals in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer system 124 may be displayed for user viewing using local or remote monitors or other display units. One approach to analyzing seismic data is to associate the data with portions of a seismic cube representing represent the subterranean formation 100. The seismic cube can also be display results of the analysis of the seismic data associated with the seismic survey.

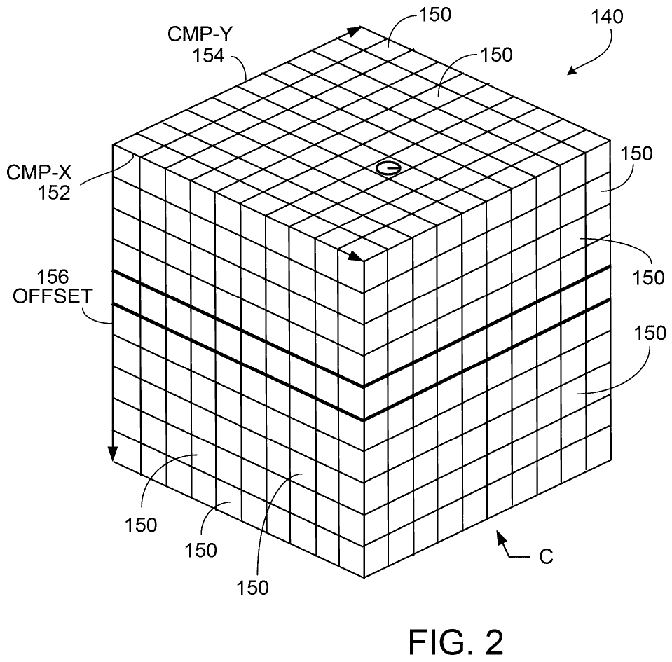

FIG. 2 illustrates a seismic cube 140 representing at least a portion of the subterranean formation 100. The seismic cube 140 is composed of a number of voxels 150. A voxel is a volume element, and each voxel corresponds, for example, with a seismic sample along a seismic trace. The cubic volume C is composed along intersection axes of offset spacing times based on a delta-X offset spacing 152, a delta-Y offset spacing 154, and a Delta-Z offset spacing 156. Within each voxel 150, statistical analysis can be performed on data assigned to that voxel to determine, for example, multimodal distributions of travel times and derive robust travel time estimates (according to mean, median, mode, standard deviation, kurtosis, and other suitable statistical accuracy analytical measures) related to azimuthal sectors allocated to the voxel 150.

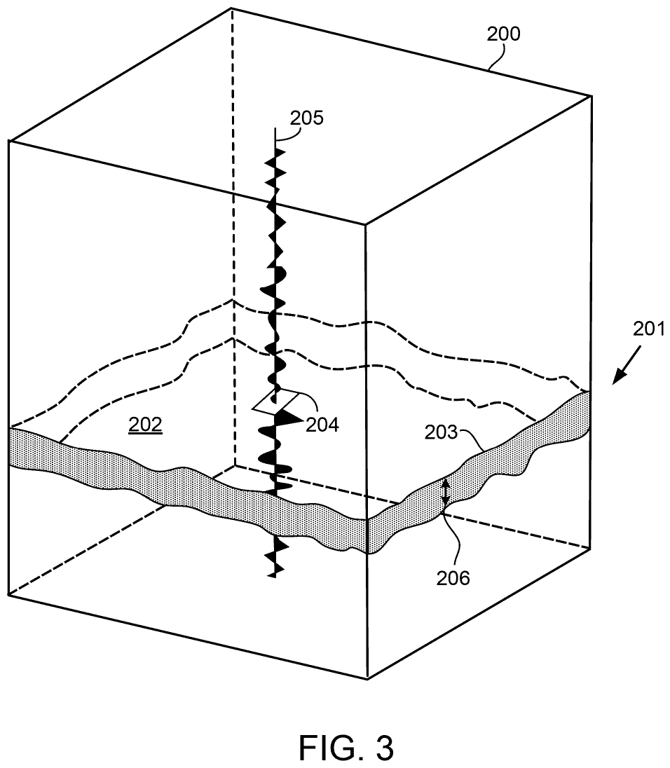

FIG. 3 illustrates a seismic cube 200 representing a formation. The seismic cube has a stratum 201 based on a surface (for example, amplitude surface 202) and a stratigraphic horizon 203. The amplitude surface 202 and the stratigraphic horizon 203 are grids that include many cells such as exemplary cell 204. Each cell is a seismic trace representing an acoustic wave. Each seismic trace has an x-coordinate and a y-coordinate, and each data point of the trace corresponds to a certain seismic travel time or depth (t or z). For the stratigraphic horizon 203, a time value is determined and then assigned to the cells from the stratum 201. For the amplitude surface 202, the amplitude value of the seismic trace at the time of the corresponding horizon is assigned to the cell. This assignment process is repeated for all of the cells on this horizon to generate the amplitude surface 202 for the stratum 201. In some instances, the amplitude values of the seismic trace 205 within window 206 by horizon 203 are combined to generate a compound amplitude value for stratum 201. In these instances, the compound amplitude value can be the arithmetic mean of the positive amplitudes within the duration of the window, multiplied by the number of seismic samples in the window.

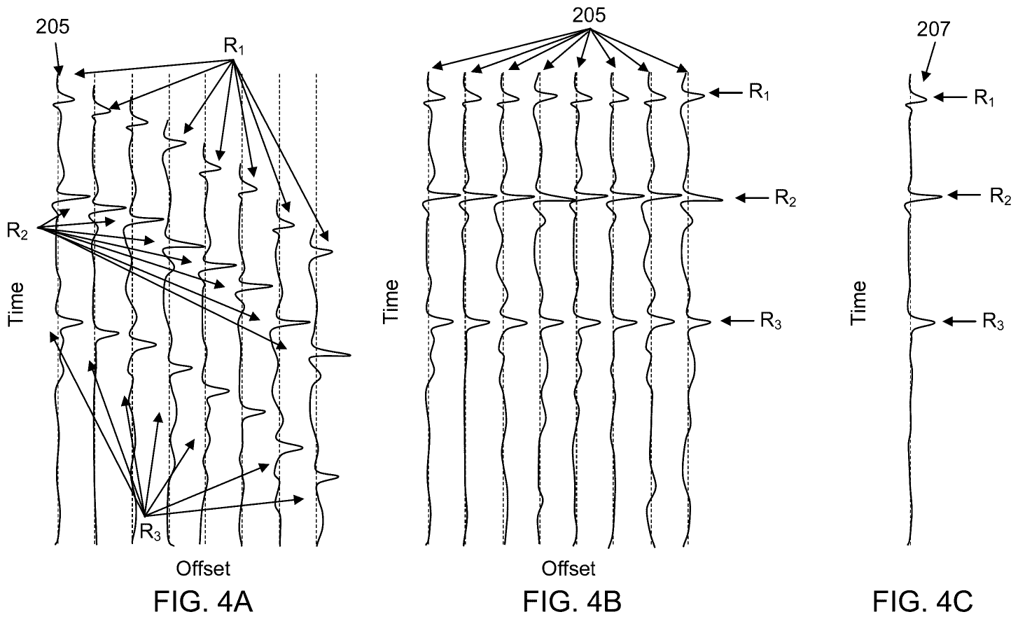

FIGS. 4A, 4B, and 4C schematically illustrate the process of stacking a group of seismic traces 205 to improve the signal to noise ratio of the traces. FIG. 4A illustrates a common midpoint (CMP) gather of eight of the seismic traces 205 generated by a set of sources and sensors that share a common midpoint. For ease of explanation, the traces are assumed to have been generated by reflections from three horizontal horizons.

The seismic traces 205 are arranged with increasing offset from the CMP. The offset of the seismic traces 205 from the CMP increases from left to right and the reflection time increases from top to bottom. Increasing offset from the common midpoint increases the angle of a seismic wave that between a source and a sensor, increases the distance the wave travels between the source and the sensor, and increases the slant reflection time. The increasing time for the reflections (R1, R2, R3) from each of the horizons to arrive for source-sensor pairs with increasing offsets from the CMP reflects this increased slant time.

FIG. 4B shows the seismic traces 205 after normal moveout (NMO) correction. NMO is the difference between vertical reflection time and the slant reflection time for a given source-sensor pair. This correction places reflections (R1, R2, R3) from common horizons at the same arrival time. The NMO correction is a function of the vertical reflection time for a specific horizon, the offset of a specific source-sensor pair, and the velocity of the seismic wave in the subterranean formation. The vertical reflection time for a specific horizon and the offset for a specific source-sensor pair are known parameters for each trace. However, the velocity is usually not readily available. As previously discussed, the velocity of seismic waves depends on properties, for example, density, porosity, and fluid content, of the medium through which the seismic waves are traveling and consequently varies with location in the subterranean formation be studied.

FIG. 4C shows a stack trace 207 generated by summing the seismic traces 205 of the CMP gather and dividing the resulting amplitudes by the number of traces in the gather. The number of traces in the gather is also referred to as the fold of the gather. The noise tends to cancel out and the reflections (R1, R2, R3) from the horizons of the subterranean formation are enhanced.

FIG. 5A shows flow diagram illustrating an example process 500 for training a data processing model for seismic fault detection, such as by the data processing system 600 of FIG. 6, subsequently described. The data processing system performs process 500 to generate output data that specifies faults or fractures in a seismic volume of a subsurface, such as those previously described in relation to FIGS. 2-3. The data processing system 500 can process seismic images generated from stacked seismic traces, such as those previously described in relation to FIGS. 4A-4C.

The seismic images processed by the data processing system can be generated from seismic traces as follows. The data processing system can be configured to receive seismic trace data representing a subterranean formation. The data processing system generates semblance spectrums from the seismic data. The semblance spectrums represent features in the subterranean formation. The data processing system smooths the semblance spectrums. The data processing system is configured to pick a stacking velocity. The data processing system refines the stacking velocity and generates a stacked image.

An example of generation of the seismic image is provided below. The data processing system receives the seismic data representing a subterranean formation from a database storing seismic data or from sensors in the field. For the two-dimensional implementation, the input data can be labeled as d(t, xₛ, x_{g}) where t is time, and xₛ and x_{g} are x coordinates of source and receiver locations at the earth surface (z=0). There are no y-coordinates in the two-dimensional implementation. A three dimensional implementation can also be performed.

The data processing system generates stacked images Iᵢ. In the CMP stacking as described with reference to FIGS. 4A-4C, seismic data traces from different source-to-receiver offsets within a CMP gather are stacked by moving them along hyperbolas to zero-offset positions and then adding them together. Equation (1) can represent this process:

$${I}_{i} ( {t}_{0} , {x}_{c} ) = {\sum }_{{x}_{off}} d ( {t}_{0} + δ ( {t}_{0} , {x}_{c} , {v}_{i} ( {t}_{0} ) ) , {x}_{c} - \frac{{x}_{off}}{2} , {x}_{c} + \frac{{x}_{off}}{2} ) \qquad ( 1 )$$

where t₀ is the initial time, x_{off} is the offset distance between a specific source and receiver, x_{c} is the center location between a specific source and receiver, νᵢ is the velocity, δ(x_{c}, νᵢ) represents the amount of time each trace is shifted, and

$$δ ( {x}_{c} , {v}_{i} ) = \sqrt{{t}_{0}^{2} + ( {x}_{{x}_{off}}^{2} / {v}_{i}^{2} )} \qquad ( 2 )$$

Here, i indicates the stacked image is made from the i^{th} trial velocity function νᵢ(t₀, x_{c}) from a range of trial velocities. The trial velocity functions are generated based on a central reference velocity. A user can specify the upper and lower bounds for the velocity search and an increment interval. The index i is a positive integer number that indicates the number of trial velocities used. Semblance is a quantitative measure of the coherence of seismic data from multiple channels at one common depth point (CDP) location. If the picked stacking velocity is correct, the events in the CDP gather after NMO correction will be flat and coherent. Computational power limits the maximum number of trial velocities that can be used. Typically, either 21 or 41 trial velocities are used. The data processing system stacks the data square according to Equations (1) and (2) to obtain Eᵢ(t₀, x_{c}), which represents the total energy within a given window.

$${E}_{i} ( {t}_{0} , {x}_{c} ) = {\sum }_{{x}_{off}} {d}^{2} ( {t}_{0} + δ ( {t}_{0} , {x}_{c} , {v}_{i} ( {t}_{0} ) ) , {x}_{c} - \frac{{x}_{off}}{2} , {x}_{c} + \frac{{x}_{off}}{2} ) \qquad ( 3 )$$

Based on the stacked images and the total energy, the semblance generation module 224 generates a semblance spectrum panel (step 262) that can be represented as

$${S}_{i} ( {t}_{0} , {x}_{c} ) = \frac{{I}_{i}^{2}}{N \cdot {E}_{i}} \qquad ( 4 )$$

where N is the number of offset source-receiver pairs. For a fixed index i, Sᵢ is a 2-dimension panel or map.

The data processing system processes the seismic images for detecting faults or fractures (or similar features) in the subsurface. The data processing system is configured to extract these features from the seismic images. The data processing system can determine, from the locations of faults, fractures, or similar features in the seismic images, where hydrocarbon extraction is easiest in the reservoir. The data processing system can recommend locations in the reservoir for drilling new wells. In some implementations, the data processing system can control drilling equipment for drilling wells at those suggested locations.

The data processing system is configured to extract features from the seismic images by training a data processing model as described in process 500. First, a non-Bayesian model for fault detection using a neural network is described. Then, the Bayesian model is described in the context of the non-Bayesian model.

For training a non-Bayesian neural network for fault the detection, the data processing system performs the following. The data processing system receives (502) seismic images forming a set of training data D=(xᵢ, yᵢ),i=1, . . . N, where N is the total number of training samples. The training samples include the seismic images and associated fault labels. xᵢ represents the seismic image volume, which can be a 2D grid or a 3D cube, such as the volumes 140, 200 of FIGS. 2-3. yᵢ represents the corresponding fault attribute labels to the seismic image volumes. While labeled faults are the example given herein, the data processing system can train the data processing model to extract other features, such as fractures, facies types, and so forth in the seismic images. The data processing system can use various features in combination to improve the fault/fractures predictions.

The data processing system generates (504) a misfit function based on cross-entropy loss, or log loss, from the input data. The cross-entropy loss measures a performance of a classification model having an output that is a probability value between 0 and 1. The cross-entropy loss increases as the predicted probability diverges from the actual label. The cross entropy loss related to the input data by a misfit function of Equation (5):

$$L = - {\sum }_{i} [ {y}_{i} log ( {N}_{θ} ( {x}_{i} ) ) + ( 1 - {y}_{i} ) log ( 1 - {N}_{θ} ( {x}_{i} ) ) ) ) ] \qquad ( 5 )$$

where N₀ is the neural network and L is the cross entropy loss.

The data processing system determines a gradient of the misfit function by automatic differentiation. The data processing system updates (506) a neural network parameter as shown in Equation (6):

$$θ ← θ - γ \frac{\partial L}{\partial θ} \qquad ( 6 )$$

where γ is a learning rate of the data processing model (e.g., the neural network). The data processing system updates the neural network parameter until either a threshold number of iterations or a threshold accuracy value is satisfied.

The data processing system can express the cross-entry loss function in Equation (5) as a probability model. The data processing system can define K as a random variable with a Bernoulli distribution. The probability mass function of K is expressed as Equation (7):

$$f ( k ; p ) = {{p}^{k} ( 1 - p )}^{1 - k} \qquad ( 7 )$$

The data processing system is configured to maximize a probability value Πᵢ for an input seismic image. This is because different input data images (samples) are independent. The data processing system maximizes the probability value Πᵢ of Equation (8):

$${\prod }_{i} {{N}_{θ} ( {x}_{i} )}^{{y}_{i}} {( 1 - {N}_{θ} )}^{1 - {y}_{i}} \qquad ( 8 )$$

The logarithm of Equation (8) returns the loss equation of Equation (5). A cross-entropy based fault detection is configured to maximum a log likelihood of a Bernoulli distribution model. This network operates as a point estimator. A minimization of the cross-entropy loss of Equation (5), in which the error is minimized in that data processing model, results in a single neural network N_{θ} with fixed parameter θ.

The data processing system using a Bayesian neural network for fault detection is now described as process 510 of FIG. 5B. Process 510 can be a modification of the process 500 of FIG. 5A. For the process 510, for a Bayesian neural network, the data processing system sets or assigns (512) the parameter of the neural network as a random variable. The data processing system defines (514) a prior p(θ) distribution which can be chosen as a Gaussian distribution, for the neural network parameter. The distribution p( [symbol] |θ) is shown in Equation (9):

$$p ( 𝒟 \vert θ ) = {\prod }_{i = 1}^{N} p ( {y}_{i} \vert {x}_{i} , θ ) = {\prod }_{i} {{N}_{θ} ( {x}_{i} )}^{{y}_{i}} {( 1 - {N}_{θ} )}^{1 - {y}_{i}} \qquad ( 9 )$$

where xᵢ represents the seismic image volume, yᵢ represents the corresponding fault attribute labels, Πᵢ denotes an operator to multiply the items within, N_{θ} represents the neural network, and p(yi|xi, θ) is a distribution associated with input image i. The data processing system determines (516), by the Bayesian formula, a posterior distribution p(θ| [symbol] ) based on Equation (10):

$$p ( θ \vert 𝒟 ) = \frac{p ( 𝒟 \vert θ ) p ( θ )}{p ( 𝒟 )} \qquad ( 10 )$$

The term p( [symbol] ) denotes the probability of the fault likelihood without considering the parameters or θ. p( [symbol] ) is intractable because the integration of Equation (11) is intractable:

$$p ( 𝒟 ) = \int p ( 𝒟 \vert θ ) p ( θ ) d θ \qquad ( 11 )$$

Based on the definition of Equation (9) for the probability distribution (likelihood), the evaluation of Equation (11) by the data processing system includes a summarization over both the seismic image samples and the parameters θ. In practice, because both the size of the training dataset and the number of neural network parameters can be large, the data processing system is computationally prohibited from determining the output of Equation (11). Instead, the data processing system generates (518) variational distribution q_{ϕ}(θ). Based on the property of variational inference, the data processing system maximizes (520) the evidence lower bound (ELBO) of Equation (12) instead:

$$ELBO = {𝔼}_{{q}_{ϕ} ( θ )} [ log p ( 𝒟 \vert θ ) p ( θ ) - log {q}_{ϕ} ( θ ) ] = {𝔼}_{{q}_{ϕ} ( θ )} log p ( 𝒟 \vert θ ) - KL ( {q}_{ϕ} ( θ ) ‖ p ( θ ) ) \qquad ( 12 )$$

where ϕ which is used for parameterization, the variational posterior distribution related to θ. KL denotes a KL divergence, which measures a distance between two distributions. The distribution shown here denotes how likely a given pixel of a seismic image represents a fault in the seismic image. The result is not based on uncertainty in the seismic images of the fault location. Given the distributions p(x) and q(x), the KL divergence is defined in Equation (13) as:

$$KL ( p ( x ) ‖ q ( x ) ) = \int p ( x ) log \frac{p ( x )}{q ( x )} dx \qquad ( 13 )$$

The ELBO of Equation (12) has no term including p( [symbol] ). The data processing system can maximize the ELBO based on a stochastic gradient ascent of Equation (14):

$$ϕ ← ϕ + γ \frac{\partial ELBO}{\partial ϕ} \qquad ( 14 )$$

FIG. 5C shows a flow diagram illustrating a process 530 for executing the data processing model trained as described in relation to process 500 of FIG. 5A and process 510 of FIG. 5B. The data processing system is configured to sample (532) from the defined variational posterior p_{ϕ}(θ) to obtain the neural network parameters The data processing system obtains the neural network parameter from the sampled variational posterior. For each sample, the data processing system samples (534) one parameter for the neural network and then generates a prediction value. The data processing system performs (536) multiple sampling iterations per distribution, and can generate (536) predictions (e.g., inference values) for the entire variational posterior distribution. These predictions together represent the prediction y* for a new sample image x*, as shown in Equation (15).

$$y * {N}_{θ} ( {x}^{*} ) , θ \sim {p}_{ϕ} ( θ ) \qquad ( 15 )$$

For a Bayesian neural network, the weights for the trained neural network represent a distribution. Due to the inherent randomness of the parameter distributions, the data processing system can determine (538) uncertainty values for each prediction. For example, with the same input value x*, we can sample different value of the neural network parameter θ. The data processing system based on the different neural network parameters, generates and by the Bayesian neural network, determines the differences in output values for the prediction. The data processing system determines the statistical descriptions of the output values, such as the mean and variance, from which the data processing system computes uncertainty values. The uncertainty values are related to the trained neural network parameters and the training dataset. The amount of uncertainty can be based on limitations of the training dataset, such as the size or scope of the training dataset.

The data processing system can use Gaussian distributions for each of the prior and variational posterior distributions. In some implementations, the data processing system uses other distributions for the model, such as Poisson distribution, Pareto distributions, and so forth for each of the prior p(θ) and variational posterior p_{ϕ}(θ) distributions. The different distribution types affect the complexity and training efficiency.

The data processing system can use a Gaussian distribution for each of the prior p(θ) and variational posterior p_{ϕ}(θ) distributions, as shown in Equation (16):

$${p}_{θ} \sim N ( 0 , {σ}_{0}^{2} ) , {p}_{ϕ} ( θ ) \sim N ( μ , {σ}^{2} ) \qquad ( 16 )$$

where, σ₀ is user defined constant, and where μ and σ are the parameters to be optimized. For two Gaussian distributions [symbol] (μ₁, σ₁²), [symbol] (μ₂, σ₂²), the KL divergence between those two distributions is:

$$KL ( {𝒩}_{1} ( {μ}_{1} , {σ}_{1}^{2} ) , {𝒩}_{2} ( {μ}_{2} , {σ}_{2}^{2} ) ) = log \frac{{σ}_{2}}{{σ}_{1}} + \frac{{σ}_{1}^{2} + {( {μ}_{2} - {μ}_{1} )}^{2}}{2 {σ}_{2}^{2}} - \frac{1}{2} \qquad ( 17 )$$

Based on the Gaussian approximation, and simplifying the KL divergence based on Equation (17), Equation (12) of the ELBO is simplified as:

$$ELBO = {𝔼}_{ϵ \sim 𝒩 ( 0 , 1 )} log p ( D \vert μ + ϵ σ ) - log \frac{σ}{{σ}_{0}} + \frac{{σ}_{0}^{2} + {μ}^{2}}{2 σ} + \frac{1}{2} \qquad ( 18 )$$

The updating formula of Equation (14) becomes:

$$μ ← μ + {γ}_{1} \frac{\partial ELBO}{\partial μ} \qquad ( 19 )$$

where, γ₁ and γ2 are the learning rates.

FIG. 6 shows an illustration of a data processing system 600. The data processing system 600 can be configured to execute the processes 500, 510, and 530 described previously for training a Bayesian machine learning model and executing the Bayesian machine learning model for fault and/or fraction detection in seismic images.

The data processing system 600 is configured to execute a machine learning model 608, such as the data processing models described previously in relation to FIGS. 5A-5C. Generally, the data processing system 600 is configured to process seismic image data 602 and determine a set of predictions for whether a fault or fracture is present at a location of a given region of the seismic image (e.g., a pixel or set of pixels). The system 600 includes computer processors 604. The computer processors 604 include computer-readable memory 610 and computer readable instructions 612. The system 600 also includes a machine learning system 606. The machine learning system 606 includes a machine learning model 608. The machine learning model 608 can be separate from or integrated with the computer processors 604.

The computer-readable medium 610 (or computer-readable memory) can include any data storage technology type which is suitable to the local technical environment, including but not limited to semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like. In an embodiment, the computer-readable medium 610 includes code-segment having executable instructions.

The machine learning system 606 is capable of applying machine learning techniques to train the machine learning model 608, as described in relation to FIGS. 5A-5B. As part of the training of the machine learning model 608, the machine learning system 606 forms a training set of input data by identifying a positive training set of input data items that have been labeled to have the property in question, such as faults or fractures, and, in some embodiments, forms a negative training set of input data items that lack the property in question.

The machine learning system 606 extracts feature values from the input data of the training set, the features being variables deemed potentially relevant to whether or not the input data items have the associated property or properties. An ordered list of the features for the input data is herein referred to as the feature vector for the input data. In one embodiment, the machine learning system 606 applies dimensionality reduction (e.g., via linear discriminant analysis (LDA), principal component analysis (PCA), or the like) to reduce the amount of data in the feature vectors for the input data to a smaller, more representative set of data.

In some implementations, the machine learning model 608 is based on a convolutional neural network (CNN) wherein the network parameter is a distribution, as described previously. A CNN can be configured based on a presumption that inputs to the CNN correspond to image pixel data for an image or other data that includes features at multiple spatial locations. For example, sets of inputs can form a multi-dimensional data structure, such as a tensor, which represent color features of an example digital image (e.g., a seismic image or set of seismic images). In some implementations, inputs to the CNN correspond to a variety of other types of data, such as logging while drilling (LWD) data, resistivity data, or various types of one-dimensional or multiple dimensional data. A convolutional layer of the CNN can process the inputs to transform features of the image that are represented by inputs of the data structure. For example, the inputs are processed by performing dot product operations using input data along a given dimension of the data structure and a set of parameters for the convolutional layer.

Performing computations for a convolutional layer can include applying one or more sets of kernels to portions of inputs in the data structure. The manner in which CNN performs the computations can be based on specific properties for each layer of an example multi-layer neural network or deep neural network that supports deep neural net workloads. A deep neural network can include one or more convolutional towers (or layers) along with other computational layers. In particular, for example computer vision applications, these convolutional towers often account for a large proportion of the inference calculations that are performed. Convolutional layers of a CNN can have sets of artificial neurons that are arranged in three dimensions, a width dimension, a height dimension, and a depth dimension. The depth dimension corresponds to a third dimension of an input or activation volume and can represent respective color channels of an image. For example, input images can form an input volume of data (e.g., activations), and the volume has dimensions 32×32×3 (width, height, depth respectively). A depth dimension of 3 can correspond to the RGB color channels of red (R), green (G), and blue (B).

In general, layers of a CNN are configured to transform the three dimensional input volume (inputs) to a multi-dimensional output volume of neuron activations (activations). For example, a 3D input structure of 32×32×3 holds the raw pixel values of an example image, in this case an image of width 32, height 32, and with three color channels, R, G, and B. A convolutional layer of a CNN of the machine learning model 608 computes the output of neurons that may be connected to local regions in the input volume. Each neuron in the convolutional layer can be connected only to a local region in the input volume spatially, but to the full depth (e.g., all color channels) of the input volume. For a set of neurons at the convolutional layer, the layer computes a dot product between the parameters (weights) for the neurons and a certain region in the input volume to which the neurons are connected. This computation may result in a volume such as 32×32×12, where 12 corresponds to a number of kernels that are used for the computation. A neuron's connection to inputs of a region can have a spatial extent along the depth axis that is equal to the depth of the input volume. The spatial extent corresponds to spatial dimensions (e.g., x and y dimensions) of a kernel.

A set of kernels can have spatial characteristics that include a width and a height and that extends through a depth of the input volume. Each set of kernels for the layer is applied to one or more sets of inputs provided to the layer. That is, for each kernel or set of kernels, the machine learning model 608 can overlay the kernel, which can be represented multi-dimensionally, over a first portion of layer inputs (e.g., that form an input volume or input tensor), which can be represented multi-dimensionally. For example, a set of kernels for a first layer of a CNN may have size 5×5×3×16, corresponding to a width of 5 pixels, a height of 5 pixel, a depth of 3 that corresponds to the color channels of the input volume to which to a kernel is being applied, and an output dimension of 16 that corresponds to a number of output channels. In this context, the set of kernels includes 16 kernels so that an output of the convolution has a depth dimension of 16.

The machine learning model 608 can then compute a dot product from the overlapped elements. For example, the machine learning model 608 can convolve (or slide) each kernel across the width and height of the input volume and compute dot products between the entries of the kernel and inputs for a position or region of the image. Each output value in a convolution output is the result of a dot product between a kernel and some set of inputs from an example input tensor. The dot product can result in a convolution output that corresponds to a single layer input, e.g., an activation element that has an upper-left position in the overlapped multi-dimensional space. As discussed above, a neuron of a convolutional layer can be connected to a region of the input volume that includes multiple inputs. The machine learning model 608 can convolve each kernel over each input of an input volume. The machine learning model 608 can perform this convolution operation by, for example, moving (or sliding) each kernel over each input in the region.

The machine learning model 608 can move each kernel over inputs of the region based on a stride value for a given convolutional layer. For example, when the stride is set to 1, then the machine learning model 608 can move the kernels over the region one pixel (or input) at a time. Likewise, when the stride is 2, then the machine learning model 608 can move the kernels over the region two pixels at a time. Thus, kernels may be shifted based on a stride value for a layer and the machine learning model 608 can repeatedly perform this process until inputs for the region have a corresponding dot product. Related to the stride value is a skip value. The skip value can identify one or more sets of inputs (2×2), in a region of the input volume, that are skipped when inputs are loaded for processing at a neural network layer. In some implementations, an input volume of pixels for an image can be “padded” with zeros, e.g., around a border region of an image. This zero-padding is used to control the spatial size of the output volumes.

As discussed previously, a convolutional layer of CNN is configured to transform a three dimensional input volume (inputs of the region) to a multi-dimensional output volume of neuron activations. For example, as the kernel is convolved over the width and height of the input volume, the machine learning model 608 can produce a multi-dimensional activation map that includes results of convolving the kernel at one or more spatial positions based on the stride value. In some cases, increasing the stride value produces smaller output volumes of activations spatially. In some implementations, an activation can be applied to outputs of the convolution before the outputs are sent to a subsequent layer of the CNN.

An example convolutional layer can have one or more control parameters for the layer that represent properties of the layer. For example, the control parameters can include a number of kernels, K, the spatial extent of the kernels, F, the stride (or skip), S, and the amount of zero padding, P. Numerical values for these parameters, the inputs to the layer, and the parameter values of the kernel for the layer shape the computations that occur at the layer and the size of the output volume for the layer. In some implementations, the spatial size of the output volume is computed as a function of the input volume size, W, using the formula (W−F+2P)/S+1. For example, an input tensor can represent a pixel input volume of size [227×227×3]. A convolutional layer of a CNN can have a spatial extent value of F=11, a stride value of S=4, and no zero-padding (P=0). Using the above formula and a layer kernel quantity of K=116, the machine learning model 608 performs computations for the layer that results in a convolutional layer output volume of size [55×55×156], where 55 is obtained from [(227−11+0)/4+1=55].

The computations (e.g., dot product computations) for a convolutional layer, or other layers, of a CNN involve performing mathematical operations, e.g., multiplication and addition, using a computation unit of a hardware circuit of the machine learning model 608. The design of a hardware circuit can cause a system to be limited in its ability to fully utilize computing cells of the circuit when performing computations for layers of a neural network.

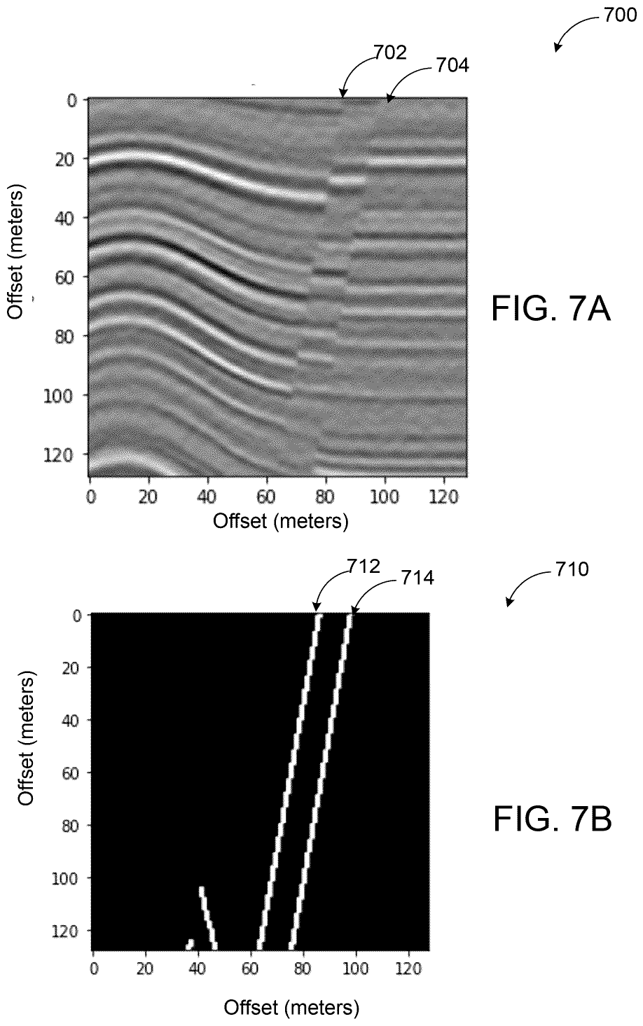

FIGS. 7A-7B show example training data for the data processing model described in relation to FIGS. 5A-6. Image 700 of FIG. 7A includes an example of a seismic image that is preprocessed as described in relation to FIGS. 1-4C. Discontinuities in the seismic image are shown at locations 702, 704. These discontinuities can represent faults or fractures. Image 710 of FIG. 7B includes an example of a label of the faults or fractures present in the seismic image 700. The discontinuities 702 and 704 in the seismic image 700 are labeled as faults 712 and 714, respectively. The labeling includes marking the locations of the faults 712, 714 in the labeled seismic image 710 with binary values (e.g., “1”) indicating the presence of the desired feature/attribute at that location in the corresponding seismic image 700. The rest of the image 710 is marked as not including the feature/attribute, such as with a binary value of “0.”

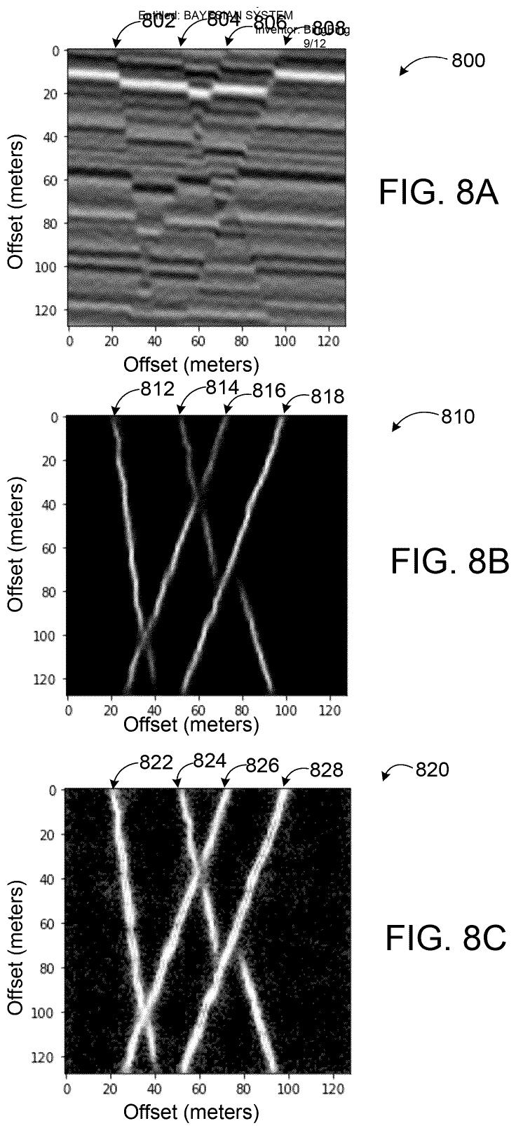

FIGS. 8A, 8B, and 8C show respective images 800, 810, and 820. Image 800 represents a seismic image input to a data processing model, such as the Bayesian neural network described herein. Image 810 represents an average of 100 output predictions by the data processing model for the seismic image 800. Image 820 represents an uncertainty analysis that corresponds to the average of the outputs in image 810. Specifically, the image 820 represents a corresponding standard deviation of the outputs of image 810. The average of the outputs an image 810 and the corresponding standard deviation values in image 820 are computed by the Bayesian neural network.

As shown in seismic image 800, a set of fractures or faults 802, 804, 806, and 808 are present within the seismic image. The data processing model is configured to execute the machine learning process to identify these faults or fractures and generate locations of the predicted faults or fractures within the seismic image 800. The output predictions are shown in image 810. The data processing model predicts that faults are located at locations 812, 814, 816, and 818 within the image 810.

The data processing model generates the output image 810 by sampling 100 times the neural network parameters from the variational posterior distribution for the seismic image and generating a prediction for each sample. The distribution of the neural network parameter enables the data processing model to generate multiple values for each location in the seismic image 800. The result image 810 includes an average of 100 values computed by the data processing model for the seismic image 800. The average values of image 810 can be computed pixel-wisely.

The data processing system is also configured to generate statistical data corresponding to the predictions of the locations of faults or fractures. The uncertainty analysis can represent how confident the prediction is for a given location in the subsurface. As previously described, the uncertainty analysis enables a more precise control over where hydrocarbon wells are to be drilled in the subsurface. The uncertainty analysis can include a representation of a standard deviation (or variance) for the output values computed for image 810. As shown in image 820, the data processing model computes a high confidence for the presence of faults or fractures at locations 822, 824, 826, and 828.

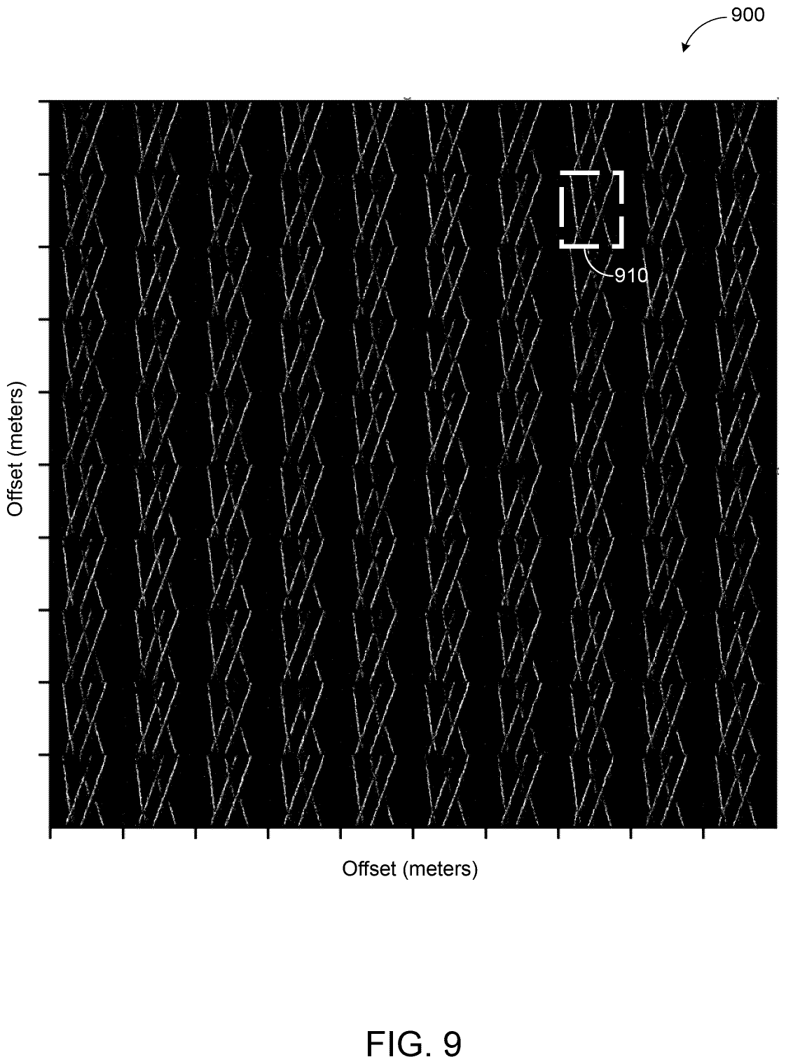

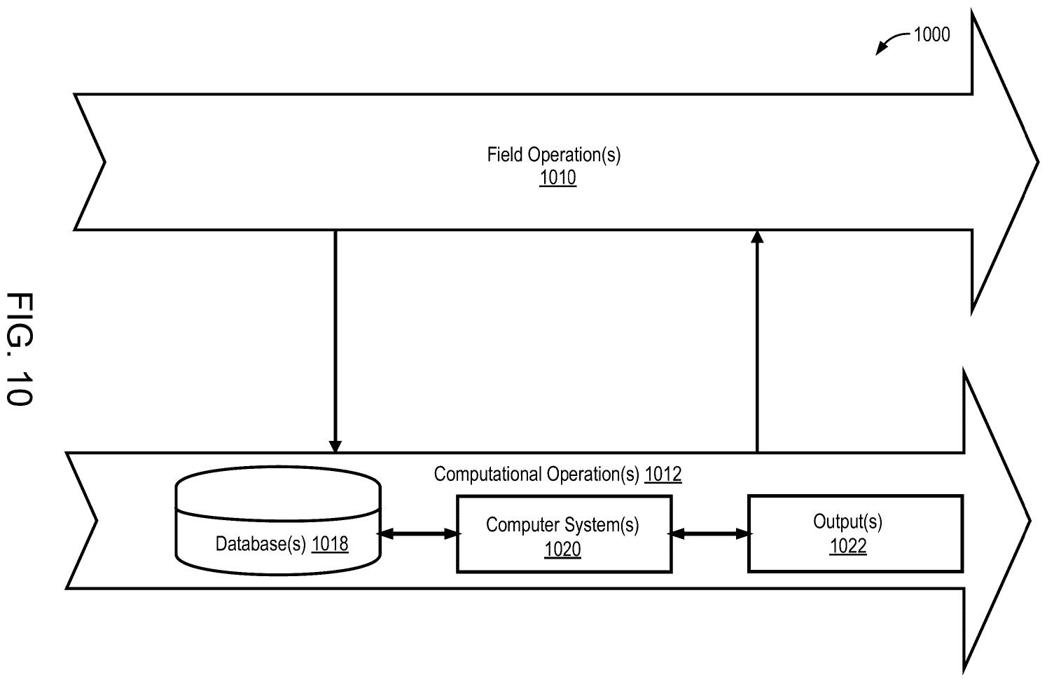

FIG. 9 shows an output image 900 including each of the 100 outputs from the Bayesian neural network by using a fixed input as shown in FIGS. 8A-8C. The data processing model samples the neural network parameters 100 times from the variational posterior distribution. While 100 iterations are used for this example, other threshold values can be selected. For example, the data processing model can be configured to iterate until a threshold uncertainty value is satisfied. For example, the threshold can be satisfied when values are below a given uncertainty or one or more locations in the seismic image.

FIG. 10 illustrates hydrocarbon production operations 1000 that include both one or more field operations 1010 and one or more computational operations 1012, which exchange information and control exploration to produce hydrocarbons. In some implementations, outputs of techniques of the present disclosure (e1.g., the method 300) can be performed before, during, or in combination with the hydrocarbon production operations 1000, specifically, for example, either as field operations 1010 or computational operations 1012, or both. For example, the processes 300, 400 collect data during field operations, processes the data in computational operations, and can determine locations to perform additional field operations.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively, or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 10 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

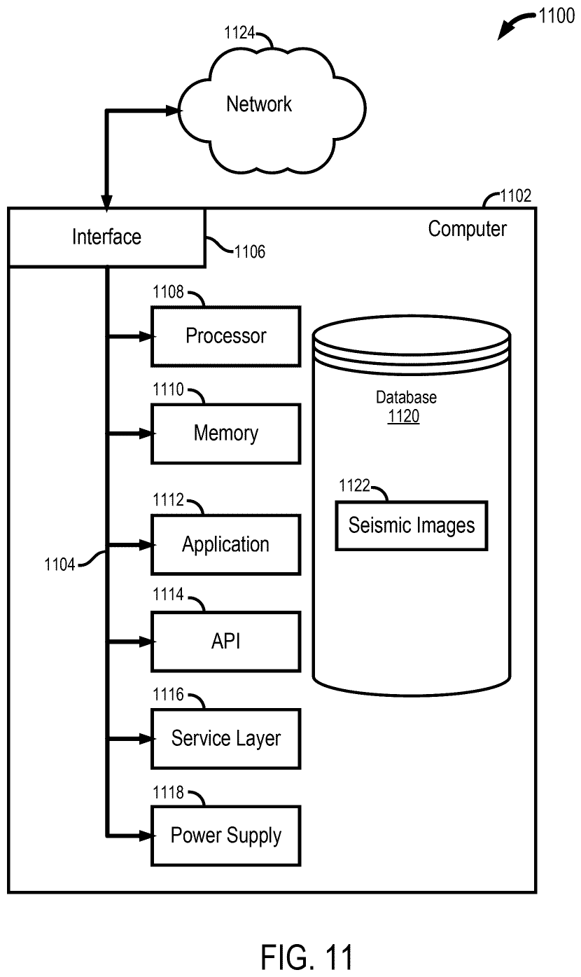

FIG. 11 is a block diagram of an example computer system 1100 used to provide computational functionalities associated with described algorithms, methods, functions, processes, flows, and procedures described in the present disclosure, according to some implementations of the present disclosure. The illustrated computer 1102 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1102 can include input devices such as keypads, keyboards, and touch screens that can accept user information. Also, the computer 1102 can include output devices that can convey information associated with the operation of the computer 1102. The information can include digital data, visual data, audio information, or a combination of information. The information can be presented in a graphical user interface (UI) (or GUI).

The computer 1102 can serve in a role as a client, a network component, a server, a database, a persistency, or components of a computer system for performing the subject matter described in the present disclosure. The illustrated computer 1102 is communicably coupled with a network 1124. In some implementations, one or more components of the computer 1102 can be configured to operate within different environments, including cloud-computing-based environments, local environments, global environments, and combinations of environments.

The computer 1102 can include an electronic computing device operable to receive, transmit, process, store, and manage data and information associated with the described subject matter. According to some implementations, the computer 1102 can also include, or be communicably coupled with, an application server, an email server, a web server, a caching server, a streaming data server, or a combination of servers.

The computer 1102 can receive requests over network 1124 from a client application (for example, executing on another computer 1102). The computer 1102 can respond to the received requests by processing the received requests using software applications. Requests can also be sent to the computer 1102 from internal users (for example, from a command console), external (or third) parties, automated applications, entities, individuals, systems, and computers.

Each of the components of the computer 1102 can communicate using a system bus 1104. In some implementations, any or all of the components of the computer 1102, including hardware or software components, can interface with each other or the interface 1106 (or a combination of both), over the system bus 1104. Interfaces can use an application programming interface (API) 1114, a service layer 1116, or a combination of the API 1114 and service layer 1116. The API 1114 can include specifications for routines, data structures, and object classes. The API 1114 can be either computer-language independent or dependent. The API 1114 can refer to a complete interface, a single function, or a set of APIs.

The service layer 1116 can provide software services to the computer 1102 and other components (whether illustrated or not) that are communicably coupled to the computer 1102. The functionality of the computer 1102 can be accessible for all service consumers using this service layer. Software services, such as those provided by the service layer 1116, can provide reusable, defined functionalities through a defined interface. For example, the interface can be software written in JAVA, C++, or a language providing data in extensible markup language (XML) format. While illustrated as an integrated component of the computer 1102, in alternative implementations, the API 1114 or the service layer 1116 can be stand-alone components in relation to other components of the computer 1102 and other components communicably coupled to the computer 1102. Moreover, any or all parts of the API 1114 or the service layer 1116 can be implemented as child or sub-modules of another software module, enterprise application, or hardware module without departing from the scope of the present disclosure.

The computer 1102 includes an interface 1106. Although illustrated as a single interface 1106 in FIG. 11, two or more interfaces 1106 can be used according to implementations of the computer 1102 and the described functionality. The interface 1106 can be used by the computer 1102 for communicating with other systems that are connected to the network 1124 (whether illustrated or not) in a distributed environment. Generally, the interface 1106 can include, or be implemented using, logic encoded in software or hardware (or a combination of software and hardware) operable to communicate with the network 1124. More specifically, the interface 1106 can include software supporting one or more communication protocols associated with communications. As such, the network 1124 or the interface's hardware can be operable to communicate physical signals within and outside of the illustrated computer 1102.

The computer 1102 includes a processor 1108. Although illustrated as a single processor 1108 in FIG. 11, two or more processors 1108 can be used according to implementations of the computer 1102 and the described functionality. Generally, the processor 1108 can execute instructions and can manipulate data to perform the operations of the computer 1102, including operations using algorithms, methods, functions, processes, flows, and procedures as described in the present disclosure.

The computer 1102 also includes a database 1120 that can hold data (such geomechanics data 1122) for the computer 1102 and other components connected to the network 1124 (whether illustrated or not). For example, database 1120 can be in-memory or a database storing data consistent with the present disclosure. In some implementations, database 1120 can be a combination of two or more different database types (for example, hybrid in-memory and conventional databases) according to implementations of the computer 1102 and the described functionality. Although illustrated as a single database 1120 in FIG. 11, two or more databases (of the same, different, or combination of types) can be used according to implementations of the computer 1102 and the described functionality. While database 1120 is illustrated as an internal component of the computer 1102, in alternative implementations, database 1120 can be external to the computer 1102.

The computer 1102 also includes a memory 1110 that can hold data for the computer 1102 or a combination of components connected to the network 1124 (whether illustrated or not). Memory 1110 can store any data consistent with the present disclosure. In some implementations, memory 1110 can be a combination of two or more different types of memory (for example, a combination of semiconductor and magnetic storage) according to implementations of the computer 1102 and the described functionality. Although illustrated as a single memory 1110 in FIG. 11, two or more memories 1110 (of the same, different, or combination of types) can be used according to implementations of the computer 1102 and the described functionality. While memory 1110 is illustrated as an internal component of the computer 1102, in alternative implementations, memory 1110 can be external to the computer 1102.

The application 1112 can be an algorithmic software engine providing functionality according to implementations of the computer 1102 and the described functionality. For example, application 1112 can serve as one or more components, modules, or applications. Further, although illustrated as a single application 1112, the application 1112 can be implemented as multiple applications on the computer 1102. In addition, although illustrated as internal to the computer 1102, in alternative implementations, the application 1112 can be external to the computer 1102.

The computer 1102 can also include a power supply 1118. The power supply 1118 can include a rechargeable or non-rechargeable battery that can be configured to be either user- or non-user-replaceable. In some implementations, the power supply 1118 can include power-conversion and management circuits, including recharging, standby, and power management functionalities. In some implementations, the power-supply 1118 can include a power plug to allow the computer 1102 to be plugged into a wall socket or a power source to, for example, power the computer 1102 or recharge a rechargeable battery.

There can be any number of computers 1102 associated with, or external to, a computer system including the computer 1102, with each computer 1102 communicating over network 1124. Further, the terms “client,” “user,” and other appropriate terminology can be used interchangeably, as appropriate, without departing from the scope of the present disclosure. Moreover, the present disclosure contemplates that many users can use one computer 1102 and one user can use multiple computers 1102.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments have been described. Nevertheless, it will be understood that various modifications may be made without departing from the scope of the data processing system described herein. Accordingly, other embodiments are within the scope of the following claims.

What is claimed is:

1. A method for identifying faults or fractures in a subsurface for performing hydrocarbon extraction, the method comprising:
receiving a seismic image generated from a plurality of seismic traces, the seismic image representing features in the subsurface based on reflections of the plurality of seismic traces;
accessing a data processing model, the data processing model trained to generate output values based on a prior distribution associated with one or more machine learning parameters and a posterior distribution associated with the one or more machine learning parameters;
processing the seismic image using the data processing model, the processing including:
sampling a value from the posterior distribution;
updating the one or more machine learning parameters based on the sampled value; and
generating a prediction value for one or more locations in the seismic image, the prediction value specifying a presence or absence of a fault or fracture at a location in the seismic image; and
based on the processing, generating an uncertainty value associated with the prediction value, the uncertainty value based on processing the seismic image with at least two values from the posterior distribution; and
generating an output representation of the uncertainty value and the prediction value specifying the presence or the absence of the fault or the fracture at the location in the seismic image.

2. The method of claim 1, further comprising:
based on the prediction value and the uncertainty value, generating a control signal configured for causing drilling of a well in the subsurface corresponding to the location in the seismic image.

3. The method of claim 1, wherein the data processing model comprises a Bayesian neural network.

4. The method of claim 1, wherein the data processing model is trained using one or more seismic images labeled with fault or fracture labels, wherein the training comprises maximizing an evidence lower bound value based on a stochastic gradient ascent.

5. The method of claim 1, further comprising performing iterations of the processing the seismic image using the data processing model until a threshold value is satisfied for the uncertainty for at least one location in the seismic image.

6. The method of claim 1, wherein sampling comprises a random sampling across the posterior distribution.

7. The method of claim 1, wherein the distribution comprises a Gaussian distribution.

8. The method of claim 1, wherein a machine learning parameter of the one or more machine learning parameters comprises a neural network bias value.

9. The method of claim 1, wherein a machine learning parameter of the one or more machine learning parameters comprises a neural network weight value.

10. The method of claim 1, wherein the location in the seismic image comprises a pixel in the seismic image.

11. A system for identifying faults or fractures in a subsurface for performing hydrocarbon extraction, the system comprising:
at least one processor; and
a memory storing instructions that, when executed by the at least one processor, cause the at least one processor to perform operations comprising:
receiving a seismic image generated from a plurality of seismic traces, the seismic image representing features in the subsurface based on reflections of the plurality of seismic traces;
accessing a data processing model, the data processing model trained to generate output values based on a prior distribution associated with one or more machine learning parameters and a posterior distribution associated with the one or more machine learning parameters;
processing the seismic image using the data processing model, the processing including:
sampling a value from the posterior distribution;
updating the one or more machine learning parameters based on the sampled value; and
generating a prediction value for one or more locations in the seismic image, the prediction value specifying a presence or absence of a fault or fracture at a location in the seismic image;
based on the processing, generating an uncertainty value associated with the prediction value, the uncertainty value based on processing the seismic image with at least two values from the posterior distribution; and
generating an output representation of the uncertainty value and the prediction value specifying the presence or the absence of the fault or the fracture at the location in the seismic image.

12. The system of claim 11, the operations further comprising:
based on the prediction value and the uncertainty value, generating a control signal configured for causing drilling of a well in the subsurface corresponding to the location in the seismic image.

13. The system of claim 11, wherein the data processing model comprises a Bayesian neural network.

14. The system of claim 11, wherein the data processing model is trained using one or more seismic images labeled with fault or fracture labels, wherein the training comprises maximizing an evidence lower bound value based on a stochastic gradient ascent.

15. The system of claim 11, the operations further comprising performing iterations of the processing the seismic image using the data processing model until a threshold value is satisfied for the uncertainty for at least one location in the seismic image.

16. The system of claim 11, wherein sampling comprises a random sampling across the posterior distribution.

17. One or more non-transitory computer readable media storing instructions for identifying faults or fractures in a subsurface for performing hydrocarbon extraction, the instructions, when executed by at least one processor, configured to cause the at least one processor to perform operations comprising:
receiving a seismic image generated from a plurality of seismic traces, the seismic image representing features in the subsurface based on reflections of the plurality of seismic traces;
accessing a data processing model, the data processing model trained to generate output values based on a prior distribution associated with one or more machine learning parameters and a posterior distribution associated with the one or more machine learning parameters;
processing the seismic image using the data processing model, the processing including:
sampling a value from the posterior distribution;
updating the one or more machine learning parameters based on the sampled value; and
generating a prediction value for one or more locations in the seismic image, the prediction value specifying a presence or absence of a fault or fracture at a location in the seismic image; and
based on the processing, generating an uncertainty value associated with the prediction value, the uncertainty value based on processing the seismic image with at least two values from the posterior distribution; and
generating an output representation of the uncertainty value and the prediction value specifying the presence or the absence of the fault or the fracture at the location in the seismic image.

18. The one or more non-transitory computer readable media of claim 17, the operations further comprising:
based on the prediction value and the uncertainty value, generating a control signal configured for causing drilling of a well in the subsurface corresponding to the location in the seismic image.

19. The one or more non-transitory computer readable media of claim 17, wherein the data processing model is trained using one or more seismic images labeled with fault or fracture labels, wherein the training comprises maximizing an evidence lower bound value based on a stochastic gradient ascent.

20. The one or more non-transitory computer readable media of claim 17, the operations further comprising performing iterations of the processing the seismic image using the data processing model until a threshold value is satisfied for the uncertainty for at least one location in the seismic image.
